(19) United States
(12) Patent Application Publication
(10) Pub. No.: US 2021/0282596 A1
(43) Pub. Date: Sep. 16, 2021

(54) COFFEE BEAN GRINDER

(71) Applicants: Hisashi Yamamoto Coffee Inc., Nagaokakyo-city, Kyoto (JP); Tetsuya Inc., Izumi-city, Osaka (JP)

(72) Inventors: Hisashi Yamamoto, Nagaokakyo-city (JP); Isamu Hiramoto, Izumi-city (JP); Atsunori Kamino, Izumi-city (JP); Takuya Higashi, Izumi-city (JP); Tomoyasu Nishida, Izumi-city (JP)

(73) Assignees: Hisashi Yamamoto Coffee Inc., Nagaokakyo-city, Kyoto (JP); Tetsuya Inc., Izumi-city, Osaka (JP)

(21) Appl. No.: 16/328,446

(22) PCT Filed: Aug. 31, 2016
(86) PCT No.: PCT/JP2016/075546

§ 371 Date: Feb. 26, 2019

(51) Int. Cl. A47J 42/40; A47J 42/50; A47J 42/20; A47J 42/16; A47J 31/06

(52) U.S. Cl. CPC A47J 42/40; A47J 42/50; A47J 31/0663; A47J 42/16; A47J 42/20

(57) ABSTRACT

A coffee bean grinder 1 has a hopper 2 into which coffee beans are inserted. The grinding unit 3 grinds coffee beans supplied from the hopper 2. The discharge unit 4 discharges coffee beans ground by the grinding unit 3. The mounting unit 5 mounts a portafilter 6 to be closely pressed against the bottom end of the discharge unit 4. The discharge unit 4 has a guide path 41 facing vertically downward, and a tapered section 42 in which the inner diameter increases towards the bottom. A sloped section 502 of a close-fitting member 50b, attached to the bottom end portion of the tapered section 42, is closely pressed against a top surface 63a of the filter basket 63 of the portafilter 6. The tapered section 42 has a hole 44 for allowing air in the airtight space to escape, thereby allowing the coffee beans to fall.

### TECHNICAL FIELD

The present invention relates to coffee bean grinders that grind coffee beans, and more particularly relates to a coffee bean grinder capable of grinding coffee beans for espresso.

### BACKGROUND ART

In general, a coffee bean grinder includes a hopper into which coffee beans are put, a grinding part that grinds the coffee beans fed from the hopper, and a discharge part that discharges the coffee beans ground by the grinding part (for example, PTL 1).

Moreover, among such coffee bean grinders, there is a coffee bean grinder that can adjust the grinding grade of coffee beans. With the coffee bean grinder, an adjustment dial is rotated to adjust the clearance between a grinder disc that is provided in the grinding part and that has radial protrusions and depressions and a prebreaker that is provided to face the grinder disc, and hence the grinding grade of coffee beans can be adjusted. The coffee beans thus ground are transferred to a paper filter or a portafilter, and then coffee or espresso can be extracted using a coffee extractor or an espresso machine.

### CITATION LIST

### Patent Literature

PTL 1: Japanese Unexamined Utility Model Registration Application Publication No. 05-005032

### SUMMARY OF INVENTION

### Technical Problem

When the coffee beans thus ground are transferred to the paper filter or the portafilter, the following problems have been hitherto pointed out.

That is, when the coffee beans thus ground are transferred to the paper filter or the portafilter, if a certain distance exists between the discharge part and the filter, the coffee beans may be scattered to the outside therefrom. To prevent this trouble, PTL 1 suggests a coffee bean grinder in which the discharge part is coupled with the filter to prevent coffee beans from being scattered to the outside. However, coffee beans for espresso are extra finely ground and have no fluidity. The extra finely ground beans may be clogged in a communication path in the middle, and in addition, it is difficult to uniformly put the coffee beams into the portafilter. Owing to this, the coffee beans have to be measured with a dedicated cup and transferred to the portafilter, and the coffee beans may be scattered to the outside at this time.

In light of the problems, an object of the present invention is to provide a coffee bean grinder that can transfer ground coffee beans to a portafilter so as not to scatter the ground coffee beans to the outside and so as to obtain uniform workability without a gap.

### Solution to Problem

That is, to solve the above-described problems, the present invention provides a coffee bean grinder including a hopper into which coffee beans are put; a grinding part that grinds the coffee beans fed from the hopper; and a discharge part that discharges the coffee beans ground by the grinding part. In the coffee bean grinder, an attachment part to which a portafilter is attached so as to come into close contact with a lower end portion of the discharge part is provided.

With this configuration, when coffee beans for espresso are extra finely ground, the coffee beans can be directly put into the portafilter. The coffee beans do not have to be transferred using a dedicated cup or the like, the coffee beans are not scattered to the outside, and the coffee beans are uniformly put. Accordingly, subsequent work can be markedly reduced.

In addition, the attachment part has a recess portion to which a protruding piece provided at an outer periphery of the portafilter is fitted.

With this configuration, the portafilter can be directly attached to the lower end portion of the discharge part. Accordingly, the portafilter does not require an additional new attachment when the portafilter is attached, and the portafilter can be attached at low cost.

Furthermore, an upper surface portion of a filter basket for putting the coffee beans into the portafilter is aligned with the lower end portion of the discharge part or a lower surface portion of a close contact member provided continuously from the lower end portion.

With this configuration, the portafilter comes into close contact, and hence the coffee beans can be put into the portafilter without a gap.

The discharge part has a tapered portion in which an inner wall is widened downward.

With this configuration, extra finely ground coffee beans can be dropped while being dispersed, the coffee beans do not adhere to an inner wall surface, and clogging in the discharge part does not occur.

In addition, a hole portion for releasing inside air to outside is provided at the tapered portion.

With this configuration, even when a space with respect to the tapered portion is closed with the portafilter, the air in the space can move from the inside to the outside. The coffee beans are dropped to the portafilter while being spread, and the coffee beans can be put into the portafilter without a gap.

### Advantageous Effects of Invention

With the present invention, in the coffee bean grinder including the hopper into which the coffee beans are put, the grinding part that grinds the coffee beans fed from the hopper, and the discharge part that discharges the coffee beans ground by the grinding part, the attachment part to which the portafilter is attached so as to come into close contact with the lower end portion of the discharge part is provided. Accordingly, when extra finely ground coffee beans are directly put into the portafilter, it is not required to transfer the coffee beans using a dedicated cup or the like, the coffee beans are not scattered to the outside, and the coffee beans can be uniformly put into the portafilter. Thus, subsequent work can be markedly reduced.

### BRIEF DESCRIPTION OF DRAWINGS

FIG. 1 illustrates an external appearance of a coffee bean grinder according to an embodiment of the present invention.

FIG. 2 illustrates a grinding part according to the embodiment.

FIG. 3 illustrates a discharge part and an attachment part according to the embodiment.

FIG. 4 provides a plan view and sectional views illustrating the attachment part according to the embodiment.

FIG. 5 illustrates a portafilter.

FIG. 6 illustrates a state in which coffee beans are put in the portafilter according to the embodiment.

FIG. 7 illustrates a state in which a paper bag is attached according to the embodiment.

### DESCRIPTION OF EMBODIMENTS

An embodiment of the present invention is described below with reference to the drawings.

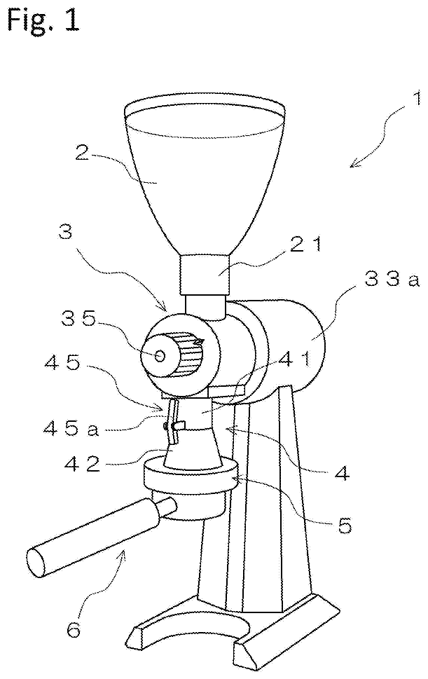

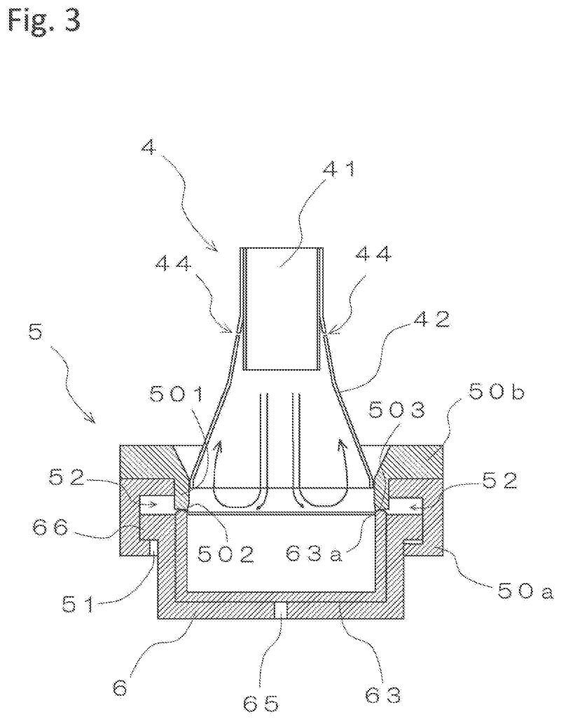

A coffee bean grinder 1 according to this embodiment can grind coffee beans with various grinding grades. As illustrated in FIG. 1, the coffee bean grinder 1 includes a hopper 2 into which coffee beans can be put, a grinding part 3 that grinds the coffee beans fed from the hopper 2, and a discharge part 4 that discharges the coffee beans ground by the grinding part 3. As illustrated in FIG. 3, the coffee bean grinder 1 includes, as a feature, an attachment part 5 to which a portafilter 6 for espresso is attached, at a lower end portion of the discharge part 4, to allow the coffee beans discharged from the discharge part 4 to be put directly into the portafilter 6. The coffee bean grinder 1 according to this embodiment is described below in detail.

First, the hopper 2 provided at the coffee bean grinder 1 has an inverted conic shape. Roasted coffee beans can be put into the hopper 2. The hopper 2 is formed of a transparent plastic resin or the like such that the amount of coffee beans can be visually recognized. The hopper 2 drops the coffee beans from an opening portion 21 provided at a lower end side of the hopper 2 toward the grinding part 3.

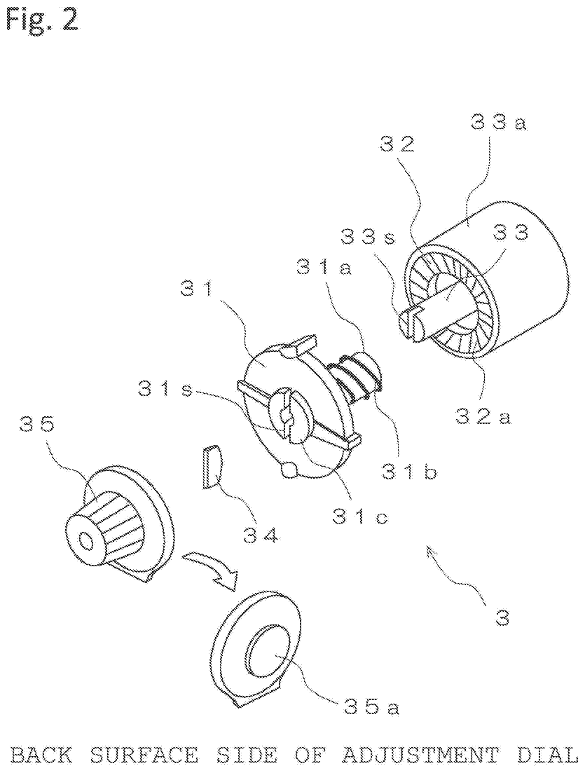

The grinding part 3 can grind the coffee beans dropped from the hopper 2. In this case, as illustrated in FIG. 2, the grinding part 3 includes a grinder disc 32 and a prebreaker 31. The grinder disc 32 has obliquely radial protrusions and depressions 32a provided on a surface of the grinder disc 32. The prebreaker 31 can rotate in a state in which the clearance width between the prebreaker 31 and the grinder disc 32 is adjusted.

An adjustment mechanism that adjusts the clearance width between the grinder disc 32 and the prebreaker 31 is described.

First, a shaft 33 of a motor 33a that rotates the prebreaker 31 is provided to protrude from the center of the grinder disc 32, is joined to the prebreaker 31 at a tip end portion of the shaft 33, and rotates the prebreaker 31. A bearing portion 31a of the prebreaker 31 is rotatably fitted on the shaft 33 of the motor, and applies a force to the prebreaker 31 in a direction away from the grinder disc 32 via a spring 31b that is provided on the outside of the bearing portion 31a. In addition, slits 31s and 33s are respectively formed in the tip end portion of the shaft 33 of the motor 33a and a center portion of the prebreaker 31. A shear plate 34 is inserted into the slits 31s and 33s to transmit the rotational force of the shaft 33 to the prebreaker 31. A circular protruding portion 31c is formed at the center portion of the prebreaker 31. A pressing portion 35a that is provided at a shaft on a back surface side of an adjustment dial 35 is pressed to the circular protruding portion 31c to move the prebreaker 31 toward the grinder disc 32. When the grinding grade of coffee beans is adjusted by using the adjustment mechanism thus configured, the adjustment dial 35 is rotated, and the pressing portion 35a provided at the center of the adjustment dial 35 is pressed toward the protruding portion 31c of the prebreaker 31. Then, the prebreaker 31 moves toward the grinder disc 32 against the force of the spring 31b, and decreases the clearance width with respect to the grinder disc 32. By rotating the motor 33a, the prebreaker 31 is rotated via the shear plate 34 provided at the tip end of the shaft 33. When the prebreaker 31 is rotated in this way, the coffee beans in the clearance with respect to the grinder disc 32 are finely ground by the obliquely radial protrusions and depressions 32a of the grinder disc 32, and are discharged to the lower discharge part 4.

The discharge part 4 discharges the coffee beans discharged from the grinding part 3 downward. As illustrated in FIG. 3, the discharge part 4 includes a communication path 41 that communicates with a lower end portion of the grinding part 3, and a tapered portion 42 that is provided to cover a lower outer peripheral portion of the communication path 41.

The communication path 41 is provided to extend from the lower side of the grinding part 3 along the vertical direction. With the communication path 41, the extra finely ground coffee beans are dropped straight. If the communication path 41 is inclined, the coffee beans extra finely ground for espresso may adhere to a wall surface of the communication path 41 and cannot be discharged straight. In addition, if the coffee beans cannot be discharged, more coffee beans are required, and when coffee beans are ground with another grinding grade, the ground coffee beans are mixed with the previous coffee beans remaining in the communication path 41. The mixture of the coffee beans changes the flavor. Owing to this, in this case, the coffee beans discharged from the lower side of the grinding part 3 are dropped straight vertically downward, and thus prevent the coffee beans from remaining in the communication path 41.

The tapered portion 42 is configured to disperse the coffee beans dropped from the communication path 41, and has a tapered shape whose inside diameter increases downward. Since the tapered portion 42 has the tapered shape, the coffee beans can be prevented from adhering to the wall surface, and the coffee beans can be uniformly dropped into the portafilter 6 attached to the lower side of the tapered portion 42.

With this configuration, as a feature, the attachment part 5 for attaching the portafilter 6 and a paper bag 7 is provided at a lower end portion 43 of the tapered portion 42.

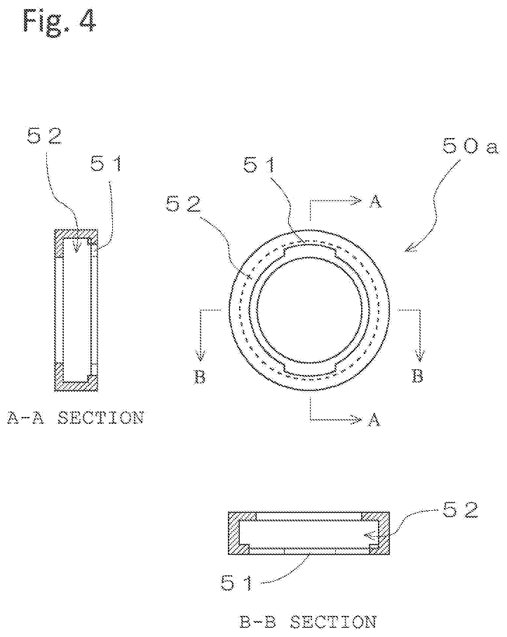

As illustrated in FIGS. 3 and 4, the attachment part 5 has a recess portion 51 and a groove portion 52 for attaching the portafilter 6, at the outer periphery of the lower end portion 43 of the tapered portion 42, and a bag holder 45 for attaching the paper bag 7.

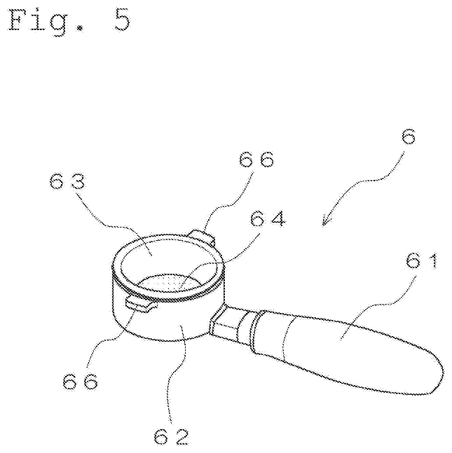

As illustrated in FIG. 5, the portafilter 6 attached to the attachment part 5 has a recess portion at a tip end of a handle 61. A filter basket 63 can be removably fitted to the recess portion. The filter basket 63 is configured to put coffee beans therein. Espresso is dripped from numerous pores 64 provided in a bottom surface of the filter basket 63. The dripped espresso is ejected from a hole portion 65 (see FIG. 3 etc.) provided at the center of the portafilter 6, and then is poured in a container such as a cup. A pair of left and right protruding pieces 66 are formed at an outer peripheral portion 62 of the portafilter 6 along the outer circumferential direction. The portafilter 6 can be used by attaching the protruding pieces 66 to an espresso machine or the like.

The attachment part 5 to which such a portafilter 6 is attached can be attached so as to hermetically seal the inner space of the tapered portion 42 by using the protruding pieces 66 of the portafilter 6. More specifically, as illustrated in FIG. 3, the attachment part 5 includes a fit member 50a to which the portafilter 6 is fitted, and a close contact member 50b with which an upper surface portion 63a of the filter basket 63 of the portafilter 6 is brought into close contact when the portafilter 6 is attached to the fit member 50a. The fit member 50a has the recess portion 51 into which the protruding pieces 66 of the portafilter 6 can be inserted from below, and the groove portion 52 formed from the recess portion 51 along the circumferential direction. The portafilter 6 is attached by inserting the protruding pieces 66 into the recess portion 51 and rotating the protruding pieces 66. The groove portion 52 is formed in a helical shape so that the protruding pieces 66 rise when the portafilter 6 is attached while being rotated. Thus, the portafilter 6 is pushed upward. Moreover, the close contact member 50b is attached to a screw thread formed on an outer peripheral portion at a lower end of the tapered portion 42. A sag portion 501 continuously sags from an inner wall surface of the tapered portion 42. The filter basket 63 comes into close contact with the sag portion 501. To prevent coffee beans from getting into a gap between the filter basket 63 and the sag portion 501 when the filter basket 63 is brought into close contact with the sag portion 501, an inclined portion 502 that is curved along an inner wall surface of the filter basket 63 is provided. Thus, coffee beans dropped from above do not get into the gap with respect to an upper surface of the filter basket 63.

In addition, when the lower side of the tapered portion 42 is covered with the portafilter 6, the inner space of the tapered portion 42 is hermetically sealed, and the inside may be pressurized as coffee beans are dropped. Then, the coffee beans may be hardly dropped from the communication path 41, and may be clogged in the communication path 41. Thus, in this case, a hole portion 44 is provided for releasing the air in the inner space of the tapered portion 42 to the outside. The hole portion 44 is provided to have a diameter that is smaller than the diameters of extra finely ground coffee beans and that allows the air to be released to the outside. Moreover, when such a hole portion 44 is provided, if the coffee beans adhere to the hole portion 44, the hole portion 44 cannot release the air. Owing to this, the hole portion 44 is provided at a position that is in an upper portion of the tapered portion 42 and that is outside the communication path 41. Since the hole portion 44 is provided at such a position, the hole portion 44 is not closed with the coffee beans, the air flows downward to a bottom portion of the filter basket 63, spreads outward, and flows upward again. Thus, the coffee beans can be uniformly spread and put into the filter basket 63.

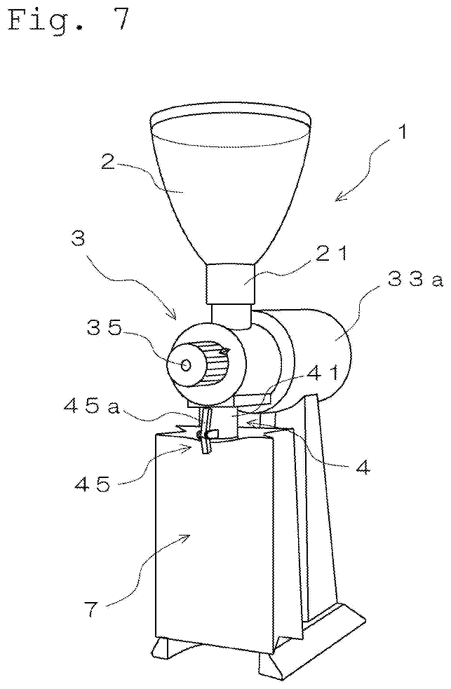

As illustrated in FIG. 7, the paper bag 7 is for a take-out of ground coffee beans, and can house coffee beans from an upper opening portion. The bag holder 45 to which the paper bag 7 is attached is provided with a lever 45a that attaches the paper bag 7 to an outer peripheral portion of the communication path 41 so as to cover the discharge part 4, and a spring (not illustrated) that presses a lower end portion of the lever 45a toward the communication path 41. The paper bag 7 is set to cover the discharge part 4, and in this state, an area around the opening portion is pressed and fixed with the lever 45a. Since the lever 45a is provided at the outer peripheral portion of the communication path 41 in this way, the paper bag 7 can be pressed and fixed. In addition, when the portafilter 6 is attached and coffee beans are put into the portafilter 6, a small amount of coffee beans remaining in the communication path 41 and the tapered portion 42 are dropped into the portafilter 6 by several times of knocking with the lever 45a.

A method of using the coffee bean grinder 1 thus configured is described next.

First, when coffee beans for espresso are to be ground, roasted coffee beans are put into the hopper 2. At this time, an amount of coffee beans that can exactly fill the portafilter 6 is put into the hopper 2.

At the time of putting the coffee beans into the hopper 2, the portafilter 6 is attached to the lower end side of the discharge part 4. When the portafilter 6 is to be attached, the protruding pieces 66 provided at the outer periphery thereof are fitted to the recess portion 51, the handle 61 is turned in this state, and hence the protruding pieces 66 are held by the groove portion 52. Then, as illustrated in FIG. 3, the inclined portion 502 that is a lower surface portion of the close contact member 50b comes into close contact with the upper surface portion 63a of the filter basket 63.

Then, in the state in which the portafilter 6 is attached, the adjustment dial 35 is rotated and set to extra fine grinding. Then, the pressing portion 35a provided at the center of the adjustment dial 35 protrudes and presses the protruding portion 31c of the prebreaker 31. Thus, the prebreaker 31 moves toward the grinder disc 32.

The power is turned ON in this state to rotate the motor 33a. Then, the coffee beans dropped from the opening portion 21 of the hopper 2 get into the area between the prebreaker 31 and the grinder disc 32, and the coffee beans are extra finely ground with the obliquely radial protrusions and depressions 32a of the grinder disc 32.

The ground coffee beans are dropped in the vertical direction from the lower side of the grinding part 3 via the communication path 41, and are dropped into the filter basket 63 in a state in which the coffee beans are dispersed by the tapered portion 42. At this time, since the upper surface portion 63a of the filter basket 63 and the inclined portion 502 of the close contact member 50b are in close contact with each other, the coffee beans can be put without a gap at the wall surface of the filter basket 63.

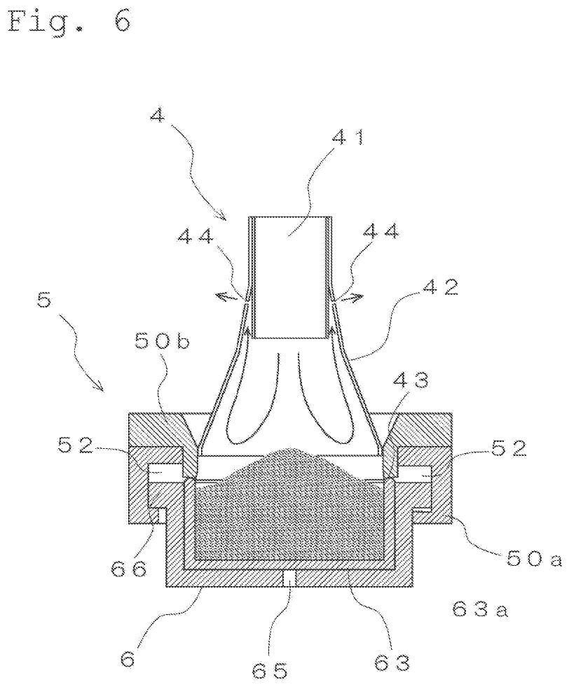

When the coffee beans thus extra finely ground in this way are dropped from the tapered portion 42, the air cannot be released from the inner space of the tapered portion 42 that is hermetically closed with the portafilter 6, and the inner space is pressurized. However, since the hole portion 44 is provided at the tapered portion 42 according to this embodiment, the air can be released from the hole portion 44 to the outside as the coffee beans are dropped as illustrated in FIG. 6. Thus, the coffee beans can be successively dropped.

After the coffee beans have been put into the portafilter 6 in this way, the lever 45a is knocked to drop the coffee beans adhering to the communication path 41 and so forth, and then the handle 61 of the portafilter 6 is rotated in the opposite direction to detach the protruding pieces 66 from the attachment part 5. Then, mountain-shaped coffee beans are flattened and pressed, the portafilter 6 is attached to an espresso machine, and espresso is extracted.

When coffee beans for coarse grinding are to be ground, as illustrated in FIG. 7, coffee beans are put into the hopper 2 and the paper bag 7 is attached. When the paper bag 7 is attached, the paper bag 7 is set to cover the discharge part 4, and the area around the opening portion thereof is pressed and fixed with the lever 45a.

In the state in which the paper bag 7 is attached, the adjustment dial 35 is rotated and set to coarse grinding. Then, the pressing portion 35a provided at the center of the adjustment dial 35 is retracted to the inside, the prebreaker 31 moves away from the grinder disc 32, and the clearance between the prebreaker 31 and the grinder disc 32 increases.

When the power is turned ON and the motor 33a is rotated in this state, the coffee beans dropped from the opening portion 21 of the hopper 2 get into the area between the prebreaker 31 and the grinder disc 32, and the coffee beans are coarsely ground with the obliquely radial protrusions and depressions 32a of the grinder disc 32.

The ground coffee beans are dropped in the vertical direction from the lower side of the grinding part 3 via the communication path 41 and the tapered portion 42, and dropped into the paper bag 7.

After the coffee beans have been put into the paper bag 7 in this way, the lever 45a is tilted on the opposite side, the paper bag 7 is removed, and the opening portion is welded, to put the coffee beans in the paper bag 7 up for sale as take-out coffee beans.

With the above-described embodiment, in the coffee bean grinder 1 including the hopper 2 into which the coffee beans are put, the grinding part 3 that grinds the coffee beans fed from the hopper 2, and the discharge part 4 that discharges the coffee beans ground by the grinding part 3, the attachment part 5 to which the portafilter 6 is attached so as to come into close contact with the lower end portion of the discharge part 4 is provided. Accordingly, extra finely ground coffee beans can be directly put into the portafilter 6, it is not required to transfer the coffee beans using a dedicated cup or the like, and the coffee beans are not scattered to the outside.

In addition, the attachment part 5 has the recess portion 51 to which the protruding pieces 66 provided at the outer periphery of the portafilter 6 are fitted. Accordingly, the portafilter 6 does not require an additional new attachment when the portafilter 6 is attached, and the portafilter 6 can be attached at low cost.

Furthermore, the upper surface portion 63a of the filter basket 63 for putting the coffee beans into the portafilter 6 comes into close contact with the inclined portion 502 that is the lower surface portion of the close contact member 50b. Accordingly, the coffee beans can be put into the portafilter 6 without a gap.

The discharge part 4 has the tapered portion 42 in which the inner wall is widened downward. Accordingly, extra finely ground coffee beans do not adhere to the inner wall surface of the discharge part 4, and clogging or the like in the discharge part 4 can be prevented from occurring.

The hole portion 44 for releasing the inside air to the outside is provided at the tapered portion 42. Accordingly, even when the space with respect to the tapered portion 42 is hermetically sealed with the portafilter 6, the air in the space can be released from the hole portion 44, and the coffee beans can be dropped and put into the portafilter 6 while the inside air is released.

The present invention is not limited to the above-described embodiment, and can be implemented in various forms.

For example, while coffee beans are ground at various grinding grades in the above-described embodiment, the invention can be applied to a coffee bean grinder dedicated to extra fine grinding for espresso.

Moreover, while the coffee beans are ground using the prebreaker 31 and the grinder disc 32 in the above-described embodiment, the coffee beans may be ground by any of other methods.

Furthermore, while the small hole portion 44 is provided at the tapered portion 42 in the above-described embodiment, it is not limited thereto. A large cylindrical hole may be provided at the tapered portion 42 and the inside air may be released. In this case, the inside diameter of the hole portion 44 may be a desirable diameter as long as the coffee beans are not scattered to the outside.

While the close contact member 50b is in close contact with the filter basket 63 in the above-described embodiment, the gap may be closed by bringing the lower surface of the tapered portion 42 into close contact with the upper surface of the filter basket 63. In this case, the inner wall surface of the tapered portion 42 is aligned with the inner wall surface of the filter basket 63, so that the coffee beans are not put on the upper surface of the filter basket 63.

While the inclined portion 502 is provided at the lower surface side of the close contact member 50b in the above-described embodiment, the inclined portion 502 may have a shape that is inclined at a constant angle in addition to the surface having a curvature.

### REFERENCE SIGNS LIST

1 coffee bean grinder
2 hopper
3 grinding part
4 discharge part (42 tapered portion, 43 inner lower edge portion)
5 attachment part (51 recess portion, 52 groove portion)
6 portafilter (63a upper surface portion, 66 protruding piece)

1. A coffee bean grinder comprising:
a hopper into which coffee beans are put;
a grinding part that grinds the coffee beans fed from the hopper; and
a discharge part that discharges the coffee beans ground by the grinding part,
wherein an attachment part to which a portafilter is attached so as to come into close contact with a lower end portion of the discharge part is provided.

2. The coffee bean grinder according to claim 1, wherein the attachment part has a recess portion to which a protruding piece provided at an outer periphery of the portafilter is fitted.

3. The coffee bean grinder according to claim 1, wherein an upper surface portion of a filter basket for putting the coffee beans into the portafilter is aligned with the lower end portion of the discharge part or a lower surface portion of a close contact member provided continuously from the lower end portion.

4. The coffee bean grinder according to claim 1, wherein the discharge part has a tapered portion in which an inner wall is widened downward.

5. The coffee bean grinder according to claim 1, wherein a hole portion for releasing inside air to outside is provided at the tapered portion.
